(19) United States
(12) Patent Application Publication
(10) Pub. No.: US 2014/0231701 A1
(43) Pub. Date: Aug. 21, 2014

(54) Heat Conductive Polycarbonate Resin Composition with Excellent Impact Strength

(71) Applicant: Cheil Industries Inc., Gumi-si (KR)

(72) Inventors: Chan Gyun Shin, Uiwang-si (KR); Nam Hyun Kim, Uiwang-si (KR); Hoo Seok Lee, Uiwang-si (KR)

(73) Assignee: Cheil Industries Inc., Gumi-si (KR)

(21) Appl. No.: 13/951,539

(22) Filed: Jul. 26, 2013

(30) Foreign Application Priority Data
Feb. 21, 2013 (KR) 10-2013-0018539

(51) Int. Cl. C09K 5/14

(52) U.S. Cl. CPC C09K 5/14
USPC 252/76

(57) ABSTRACT

A polycarbonate resin composition includes (A) a polycarbonate resin, (B) a thermally conductive filler, and (C) a modified polyolefin-based copolymer. The composition can have excellent impact strength, thermal conductivity and moldability.

### CROSS-REFERENCE TO RELATED APPLICATION

This application claims priority under 35 USC Section 119 to and the benefit of Korean Patent Application No. 10-2013-0018539, filed Feb. 21, 2013, the entire disclosure of which is incorporated herein by reference.

### FIELD OF THE INVENTION

The present invention relates to a polycarbonate resin composition, more particularly, the present invention relates to a thermally conductive polycarbonate resin composition that can have excellent impact strength.

### BACKGROUND OF THE INVENTION

Due to high thermal conductivity, metal is commonly used in products such as the main body of electronic devices having a heating component, chassis, heat sink plate, and the like. The metal more quickly dissipates heat as compared to other materials, and thus the metal can protect heat-sensitive electronic components from local high temperatures. Further, metal is suitable for use in heat protective materials having complicated shapes because the metal has high mechanical strength and processability, such as required in sheeting, molding, cutting, and the like. However, metal has disadvantages, such as high density (which makes it difficult to reduce the weight of a product including the same), high cost, and the like.

In order to solve the foregoing issues of metal, there have been efforts to develop a thermally conductive (heat conductive) resin. However, due to recent high integration and high efficiency of electronic devices, such devices are subject to increased amounts of heat. In addition, it is difficult to quickly dissipate heat which occurs in the device due to increasingly thin and light weight devices. Therefore, the occurrence of local high temperatures can lead to malfunction of electronic device or ignition. Thermally conductive resins developed to date typically have low thermal conductivity, and thus it can be difficult to solve these problems using the same.

Also, in order to increase thermal conductivity of a thermally conductive resin, if the resin is filled with excess thermally conductive filler, it can be difficult to produce products using injection molding, and the like due to increased viscosity, and the strength of final products also may not be satisfactory.

Therefore, in order to maximize thermal conductivity while minimizing the amount of filler, it is important to form an efficient network of filler in resin. Also, even though excess fillers are added, in order to prevent degradation of the injection moldability, low viscosity resin should be used. However, in order to decrease the viscosity of a resin, the molecular weight of the resin should be low. Lowering the molecular weight of the resin can, however, increase the rate of reaction between molecular chains of the resin. Thus side effects such as curing reactions can occur because such reactions can occur easily in extrusion and injection molding process.

As a result, in order to prepare high thermally conductive resin which can be injection molded, the resin should have suitable fluidity to form an effective network of filler. Also the resin viscosity should be decreased to improve the filling ability of filler, and in addition the resin should have residence stability.

Korean Patent No. 227,123 relates to a polycarbonate resin composition comprising a polycarbonate, a polyolefin resin, a modified polyolefin resin, an inorganic filler, and a thermoplastic elastomer. However, to prevent degradation of impact strength, the thermoplastic elastomer must be used.

### SUMMARY OF THE INVENTION

The present invention provides a polycarbonate resin composition that can have excellent thermal conductivity.

The present invention also provides a polycarbonate resin composition that can have excellent impact strength.

The present invention further provides a polycarbonate resin composition that can have excellent moldability.

The present invention further provides a polycarbonate resin composition that can have excellent flexural modulus and flexural strength.

The present invention further provides a polycarbonate resin composition that can have excellent tensile strength and tensile elongation.

A polycarbonate resin composition of the present invention comprises (A) a polycarbonate resin, (B) a thermally conductive filler, and (C) a modified polyolefin-based copolymer.

The polycarbonate resin composition of the present invention can comprise about 0.1 to about 5 parts by weight of the modified polyolefin-based copolymer (C) based on about 100 parts by weight of a base resin comprising about 20 to about 80% by weight of the polycarbonate resin (A) and about 20 to about 80% by weight of the thermally conductive fillers (B), wherein the amounts of (A) and (B) are based on the total weight (100% by weight) of the polycarbonate resin (A) and the thermally conductive fillers (B).

The thermally conductive filler (B) of the present invention can comprise at least one of magnesium oxide, boron nitride, aluminum oxide, or a combination thereof. The thermally conductive filler (B) can be spherical shape.

The modified polyolefin-based copolymer (C) of the present invention can comprise a functional group selected from the group consisting of maleic anhydride, amine, and epoxy.

The polycarbonate resin composition of the present invention can further comprise an additive selected from the group consisting of antimicrobial agents, thermostabilizers, antioxidants, release agents, photostabilizers, inorganic additives, surfactants, coupling agents, plasticizers, compatibilizing agents, lubricants, antistatic agents, coloring agents, such as pigments and/or dyes, flame retardants, auxiliary flame retardants, anti-dripping agents, ultraviolent stabilizers, ultraviolet absorbers. UV-protecting agents and combinations thereof.

The present invention also provides a molded article prepared from the polycarbonate resin composition. In exemplary embodiments, the molded article can be fluorescent lamp.

The present invention accordingly can provide a polycarbonate resin composition that can have excellent thermally conductivity (is heat conductive), impact strength, moldability, flexural modulus, flexural strength, tensile strength, and/or tensile elongation.

### BRIEF DESCRIPTION OF THE DRAWINGS

FIG. 1 is a graph which shows increased viscosity by adding a modified polyolefin-based copolymer (C).

### DETAILED DESCRIPTION OF THE INVENTION

The present invention now will be described more fully hereinafter in the following detailed description of the invention in which some but not all embodiments of the invention are described. Indeed, this invention may be embodied in many different forms and should not be construed as limited to the embodiments set forth herein; rather, these embodiments are provided so that this disclosure will satisfy applicable legal requirements.

A polycarbonate resin composition according to the present invention comprises (A) a polycarbonate resin, (B) a thermally conductive filler, and (C) a modified polyolefin-based copolymer.

The polycarbonate resin composition of the present invention can comprise about 0.1 to about 5 parts by weight of the modified polyolefin-based copolymer (C) based on about 100 parts by weight of a base resin including about 20 to about 80% by weight of the polycarbonate resin (A) and about 20 to about 80% by weight of the thermally conductive fillers (B), wherein the amounts of (A) and (B) are based on the total weight (100% by weight) of the polycarbonate resin (A) and the thermally conductive fillers (B).

(A) Polycarbonate Resin

In the present invention, the polycarbonate resin (A) is not limited. Examples of polycarbonate resins that can be used in the present invention include without limitation aliphatic polycarbonate resins, aromatic polycarbonate resins, copolycarbonate resins thereof, copolyestercarbonate resins, polycarbonate-polysiloxane copolymer resins, and the like, and combinations thereof. Also, the polycarbonate resin (A) can have a linear or branched structure.

The polycarbonate resin (A) according to the present invention can be prepared by reacting (a1) an aromatic dihydroxy compound with (a2) a carbonate precursor.

(a1) Aromatic Dihydroxy Compound

The aromatic dihydroxy compound (a1) can be compound represented by following Chemical Formula 1 or a combination thereof:

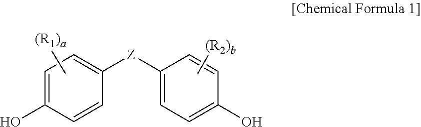

wherein R₁ and R₂ are the same or different and are each independently hydrogen, halogen, or C₁-C₈ alkyl; a and b are the same or different and are each independently an integer from 0 to 4; and Z is a single bond, C₁-C₅ alkylene, C₂-C₈ alkylidcnc, C₅-C₁₅ cycloalkylene, C₅-C₁₅ cycloalkylidene, —S—, —SO—, SO₂—, —O—, or —CO—.

Examples of the aromatic dihydroxy compound (a1) can include without limitation bis(hydroxy aryl)alkanes, bis(hydroxy aryl)cycloalkanes, bis(hydroxy aryl)ethers, bis(hydroxy aryl)sulfides, bis(hydroxy aryl)sulfoxides, biphenyl compounds, and the like. These can be used singly or as a combination of two or more.

Examples of bis(hydroxy aryl)alkanes can include, without limitation, bis(4-hydroxy phenyl)methane, bis(3-methyl-4-hydroxy phenyl)methane, bis(3-chloro-4-hydroxy phenyl)methane, bis(3,5-dibromo-4-hydroxy phenyl)methane, 1,1-bis(4-hydroxy phenyl)ethane, 1,1-bis(2-tert-butyl-4-hydroxy-3-methyl phenyl)ethane, 2,2-bis(4-hydroxy phenyl)propane (bisphenol A), 2,2-bis(3-methyl-4-hydroxy phenyl)propane, 2,2-bis(2-methyl-4-hydroxy phenyl)propane, 2,2-bis(3,5-dimethyl-4-hydroxy phenyl)propane, 1,1-bis(2-tert-butyl-4-hydroxy-5-methyl phenyl)propane, 2,2-bis(3-chloro-4-hydroxy phenyl)propane, 2,2-bis(3-fluoro-4-hydroxy phenyl)propane, 2,2-bis(3-bromo-4-hydroxy phenyl)propane, 2,2-bis(3,5-difluoro-4-hydroxy phenyl)propane, 2,2-bis(3,5-dichloro-4-hydroxy phenyl)propane, 2,2-bis(3,5-dibromo-4-hydroxy phenyl)propane, 2,2-bis(4-hydroxy phenyl)butane, 2,2-bis(4-hydroxy phenyl)octane, 2,2-bis(4-hydroxy phenyl)phenyl methane, 2,2-bis(4-hydroxy-1-methyl phenyl)propane, 1,1-bis(4-hydroxy-tert-butyl phenyl)propane, 2,2-bis(4-hydroxy-3-bromo phenyl)propane, 2,2-bis(4-hydroxy-3,5-dimethylphenyl)propane, 2,2-bis(4-hydroxy-3,5-dimethyl phenyl)propane, 2,2-bis(4-hydroxy-3-chloro phenyl)propane, 2,2-bis(4-hydroxy-3,5-dichloro phenyl)propane, 2,2-bis(4-hydroxy-3,5-dibromo phenyl)propane, 2,2-bis(4-hydroxy-3,5-dibromo phenyl)propane, 2,2-bis(3-bromo-4-hydroxy-5-chloro phenyl)propane, 2,2-bis(3-phenyl-4-hydroxy phenyl)propane, 22-bis(4-hydroxy phenyl)butane, 2,2-bis(3-methyl-4-hydroxy phenyl)butane, 1,1-bis(2-butyl-4-hydroxy-5-methyl phenyl)butane, 1,1-bis(2-tert-butyl-4-hydroxy-5-methyl phenyl)butane, 1,1-bis(2-tert-butyl-4-hydroxy-5-methyl phenyl)isobutane, 1,1-bis(2-tert-amyl-4-hydroxy-5-methyl phenyl)butane, 2,2-bis(3,5-dichloro-4-hydroxy phenyl)butane, 2,2-bis(3,5-dibromo-4-hydrophenyl)butane, 4,4-bis(4-hydroxy phenyl)heptane, 1,1-bis(2-tert-butyl-4-hydroxy-5-methyl phenyl)heptane, 2,2-bis(4-hydroxy phenyl)octane, 1,1-(4-hydroxy phenyl)ethane, and the like, and combinations thereof.

Examples of bis(hydroxy aryl)cycloalkanes can include, without limitation, 1,1-bis(4-hydroxy phenyl)cyclopentane, 1,1-bis(4-hydroxy phenyl)cyclohexane, 1,1-bi(3-methyl-4-hydroxy phenyl)cyclohexane, 1,1-bis(3-cyclohexyl-4-hydroxy phenyl)cyclohexane, 1,1-bis(3-phenyl-4-hydroxy phenyl)cyclohexane, 1,1-bis(4-hydroxy phenyl)-3,5,5-trimethylcyclohexane, and the like, and combinations thereof.

Examples of bis(hydroxy aryl)ethers can include, without limitation, bis(4-hydroxy phenyl)ether, bis(4-hydroxy-3-methyl phenyl)ether, and the like, and combinations thereof.

Examples of bis(hydroxy aryl)sulfides can include, without limitation, bis(4-hydroxy phenyl)sulfide, bis(3-methyl-4-hydroxy phenyl)sulfide, and the like, and combinations thereof.

Examples of bis(hydroxy aryl)sulfoxides can include, without limitation, bis(hydroxy phenyl)sulfoxide, bis(3-methyl-4-hydroxy phenyl)sulfoxide, bis(3-phenyl-4-hydroxy phenyl)sulfoxide, and the like, and combinations thereof.

Examples of biphenyl compounds can include, without limitation, bis(hydroxy aryl)sulfone such as bis(4-hydroxy phenyl)sulfone, bis(3-methyl-4-hydroxy phenyl)sulfone, bis(3-phenyl-4-hydroxy phenyl)sulfone, and the like; 4,4′-dihydroxy biphenyl, 4,4′-dihydroxy-2,2′-dimethylbiphenyl, 4,4′-dihydroxy-3,3′-dimethylbiphenyl, 4,4′-dihydroxy-3,3′-dicyclo biphenyl, 3,3-difluoro-4,4′-dihydroxy biphenyl, and the like, and combinations thereof.

Examples of an aromatic dihydroxy compound (a1) other than compound represented by Chemical Formula 1 can include without limitation dihydroxy benzene, halogen and/or C1-C10 alkyl substituted dihydroxy benzene, and the like, and combinations thereof. For example, without limitation, resorcinol, 3-methylresorcinol, 3-ethylresorcinol, 3-propylresorcinol, 3-butylresorcinol, 3-tert-butylresorcinol, 3-phenylresorcinol, 2,3,4,6-tetrafluororesorcinol, 2,3,4,6-tetrabromoresorcinol, catechol, hydroquinone, 3-methylhydroquinone, 3-ethylhydroquinone, 3-propylhydroquinone, 3-butylhydroquinone, 3-tert-butylhydroquinone, 3-phenylhydroquinone, 3-cumylhydroquinone, 2,5-dichlorohydroquinone, 2,3,5,6-tetramethylhydroquinone, 2,3,5,6-tetra-tert-butylhydroquinone, 2,3,5,6-tetrafluorohydroquinone, 2,3,5,6-tetrabromo hydroquinone, and the like, and combinations thereof can be used.

In exemplary embodiments, 2,2-bis(4-hydroxy phenyl)propane (bisphenol A) can be used as the aromatic dihydroxy compound (a1).

(a2) Carbonate Precursor

Examples of a carbonate precursor can include without limitation dimethyl carbonate, diethyl carbonate, dibutyl carbonate, dicyclohexyl carbonate, diphenyl carbonate, ditoly carbonxate, bis(chlorophenyl)carbonate, m-cresyl carbonate, dinaphthylcarbonate, bis(diphenyl)carbonate, carbonyl chloride (phosgene), triphosgene, diphosgene, carbonyl bromide, bishaloformate, and the like. These can be used singly or as a combination of two or more.

In the case where the polycarbonate resin is prepared by interfacial polymerization, carbonyl chloride (phosgene) can be used.

The carbonate precursor (a2) can be used in a mole ratio of about 0.9 to about 1.5 based on about 1 mole of aromatic dihydroxy compound (a1).

The polycarbonate resin (A) according to the present invention can have a weight average molecular weight of 10,000 to 200,000 g/mol, for example, 15,000 to 80,000 g/mol.

The polycarbonate resin composition according to the present invention can include about 20 to about 80% by weight of the polycarbonate resin (A) based on 100% by weight of the polycarbonate resin (A) and the thermally conductive fillers (B). In some embodiments, the polycarbonate resin composition may include the polycarbonate resin (A) in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80% by weight. Further, according to some embodiments of the present invention, the polycarbonate resin (A) may be present in an amount of from about any of the foregoing amounts to about any other of the foregoing amounts.

Within these ranges, excellent thermally conductivity, impact strength, and/or moldability of the polycarbonate resin composition can be maintained.

(B) Thermally Conductive Filler

In the present invention, the thermally conductive filler (B) improves thermal conductivity of the polycarbonate resin composition.

The thermally conductive filler (B) according to the present invention can be spherical particles for thermal conductivity and fluidity. Plate-shaped thermally conductive filler can have higher thermal conductivity than spherical thermally conductive filler because of increased contact probability and contact area between plate-shaped thermally conductive fillers. However, there are disadvantages associated with plate-shaped thermally conductive filler because thermal conductivity may not be constant depending on direction because the plate thermally conductive tiller has anisotropy in terms of thermal conductivity. Spherical thermally conductive filler (B), however, can have excellent thermal conductivity regardless of direction because such filler can have excellent thermal conductivity in the horizontal direction (in-plane), as well as in the vertical direction (z-direction). Plate-shaped thermally conductive filler can also provide excellent electric insulation.

Also, the spherical thermally conductive filler (B) can have excellent fluidity compared with plate-shaped or flake particles.

Further, to provide fluidity, the filler can have a relatively large average particle size (particle diameter). The thermally conductive filler can accordingly have a range of average particle sizes taking into account other properties.

The thermally conductive filler (B) according to the present invention can comprise about 80% or more of thermally conductive filler having an average particle size (average particle diameter) of about 30 μm to about 80 μm, for example about 40 μm to about 60 μm, based on the total weight (100% by weight) of the thermally conductive filler (B).

Also, the specific surface area (BET) of spherical particles can be about 0.4 to about 0.6 m²/g.

If the average particle diameter is less than about 30 μm, and the BET is less than about 0.4 m²/g, fluidity properties can be deteriorated. If the average particle diameter is more than about 80 μm, and the BET is more than about 0.6 m²/g, the thermal conductivity of the polycarbonate resin composition can be deteriorated.

Examples of the thermally conductive filler (B) according to the present invention can comprise without limitation magnesium oxide, boron nitride, aluminum oxide, and the like, and combinations thereof. In exemplary embodiments, magnesium oxide having excellent thermal conductivity can be used.

The polycarbonate resin composition according to the present invention can include about 20 to about 80% by weight of the thermally conductive filler (B) based on 100% by weight of the polycarbonate resin (A) and the thermally conductive fillers (B). In some embodiments, the polycarbonate resin composition may include the thermally conductive filler (B) in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80% by weight. Further, according to some embodiments of the present invention, the thermally conductive filler (B) may be present in an amount of from about any of the foregoing amounts to about any other of the foregoing amounts.

If the amount of the thermally conductive filler (B) is less than about 20% by weight, the thermal conductivity of the polycarbonate resin composition can be deteriorated. If the amount of the thermally conductive filler (B) is more than about 80% by weight, interfacial bonding properties can be deteriorated because the thermally conductive filler plays a role as impurity, and therefore, the impact strength, tensile strength, and/or flexural strength of polycarbonate resin composition can be deteriorated.

(C) Modified Polyolefin-Based Copolymer

In the present invention, the modified polyolefin-based copolymer (C) can improve impact strength and moldability of the polycarbonate resin composition. The modified polyolefin is a branched graft copolymer and comprises a polyolefin in the backbone (main chain) with functional groups grafted thereto.

The modified polyolefin-based copolymer (C) according to the present invention can be prepared by graft copolymerizing at least one compound selected from the group consisting of maleic anhydride, amine, epoxy, and combinations thereof on polyolefin in the backbone

The main chain of the modified polyolefin (C) can comprise polyethylene, polypropylene, ethylene-propylene copolymer, or a combination thereof.

The modified polyolefin-based copolymer (C) can include a compound including the functional group in an amount of about 0.2 to about 5% by weight, for example about 1.0 to about 2.0% by weight, and as another example about 1.0 to about 1.5% by weight, based on the total weight (100% by weight) of the modified polyolefin-based copolymer (C). In some embodiments, the modified polyolefin-based copolymer (C) can include a compound including the functional group in an amount of about 0.2, 0.3, 0.4, 0.5, 0.6, 0.7, 0.8, 0.9, 1, 2, 3, 4, or 5% by weight. Further, according to some embodiments of the present invention, the compound including the functional group may be present in an amount of from about any of the foregoing amounts to about any other of the foregoing amounts.

If the amount of the compound including the functional group is less than about 0.2% by weight, the composition may not have the desired impact strength. If the amount of the compound including the functional group is more than about 5% by weight, impact strength can deteriorate because of the decreasing a role of the impact reinforcing agent.

The polycarbonate resin composition can include about 0.1 to about 5 parts by weight of the modified polyolefin-based copolymer (C) based on about 100 parts by weight of a base resin including the polycarbonate resin (A) and the thermally conductive fillers (B). In some embodiments, the polycarbonate resin composition can include the modified polyolefin-based copolymer (C) in an amount of about 0.1, 0.2, 0.3, 0.4, 0.5, 0.6, 0.7, 0.8, 0.9, 1, 2, 3, 4, or 5 parts by weight. Further, according to some embodiments of the present invention, the modified polyolefin-based copolymer (C) may be present in an amount of from about any of the foregoing amounts to about any other of the foregoing amounts.

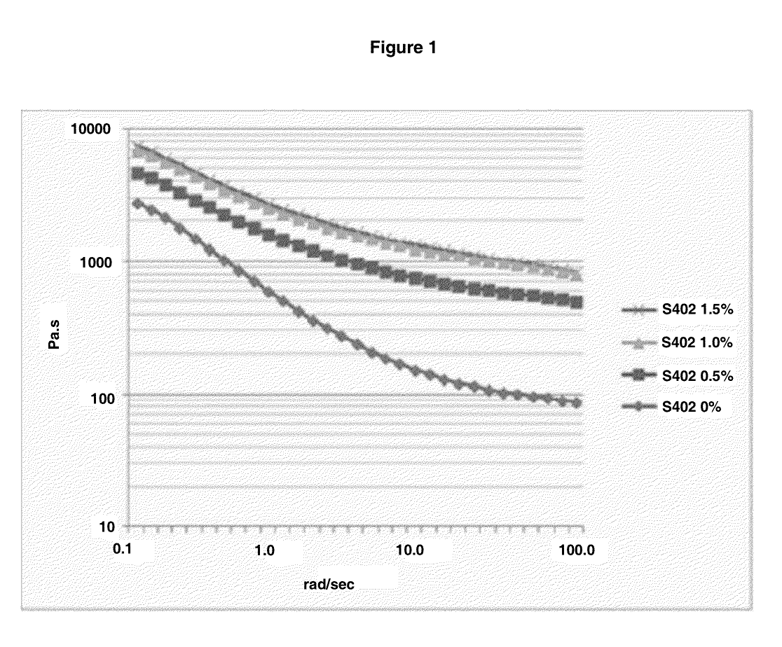

As the amount of the modified polyolefin-based copolymer (C) increases within the above range, the impact strength, as well as tensile elongation can be improved. The increase of tensile elongation appears as an increase of flexural energy, therefore practical impact strength of injection molding articles can be increased. Further, although excess filler is added, injection molding releasing property and continuous workability can be improved. Also, as shown on FIG. 1, if the amount of the modified polyolefin-based copolymer (C) increases within the above range, in special processes such as extrusion molding, processability and appearance can improve because of increasing viscosity of the polycarbonate resin composition

If the amount of the modified polyolefin-based copolymer (C) is less than about 0.1 parts by weight, the impact strength of the polycarbonate resin composition can be deteriorated. If the amount of the modified polyolefin-based copolymer (C) is more than about 5 parts by weight, the impact strength of the polycarbonate resin composition can increase, but other properties such as heat resistance and fluidity can be deteriorated.

(D) Additive(s)

The polycarbonate resin composition according to the present invention can further comprise one or more additives (D). Examples of the additives can include without limitation antimicrobial agents, thermostabilizers, antioxidants, release agents, photostabilizers, inorganic additives, surfactants, coupling agents, plasticizers, compatibilizing agents, lubricants, antistatic agents, coloring agents, such as pigments, and/or dyes, flame retardants, auxiliary flame retardants, anti-dripping agents, ultraviolent stabilizers, ultraviolet absorbers, UV-protecting agents and the like, and combinations thereof.

Examples of the antioxidant can include without limitation phenol type antioxidants, phosphite type antioxidants, thioether type antioxidants, amine type antioxidants, and the like, and combinations thereof.

Examples of the release agent can include without limitation fluorine-containing polymers, silicone oils, metal salts of stearic acid, metal salts of montanic acid, montanic acid ester waxes, polyethylene waxes, and the like, and combinations thereof.

Examples of the inorganic additive can include without limitation glass fiber, carbon fiber, silica, mica, alumina, clay, calcium carbonate, calcium sulfate, glass bead, and the like, and combinations thereof.

Examples of the pigment and/or dye can include without limitation titanium dioxide, carbon black, and the like, and combinations thereof. Examples of the carbon black can include without limitation graphitized carbon, furnace black, acetylene black, ketjen black, and the like, and combinations thereof.

Examples of the flame retardant can include without limitation phosphorus flame retardants, nitrogen flame retardants, halogen flame retardants, and the like, and combinations thereof. Examples of the auxiliary flame retardant can include without limitation antimony oxide, and the like, and combinations thereof.

Examples of the anti-dripping agent can include without limitation polytetrafluoroethylene, and the like, and combinations thereof.

Examples of the ultraviolent stabilizer can include without limitation benzophenone-type ultraviolent stabilizers, amine-type ultraviolent stabilizers, and the like, and combinations thereof.

The additive (D) can be added in an amount of about 0.1 to about 5 parts by weight based on about 100 parts by weight of the base resin comprising the polycarbonate resin (A) and the thermally conductive filler (B).

The polycarbonate resin composition according to the present invention can have a thermal conductivity of about 0.4 W/mK to about 2.0 W/mK measured for 1*1*1 mm³ specimen in accordance with ASTM E1461 using the Laser Flash Method.

The polycarbonxate resin composition according to the present invention can have a Izod notch impact strength of about 5 kgf·cm/cm to about 20 kgf·cm/cm measured for a 3.175 mm (⅛″) thick specimen in accordance with ASTM D256, and a melt flow index of about 4 g/10 min to about 25 g/10 min measured in accordance with ASTM D1238 at 250° C., under a 10 Kg load.

The polycarbonate resin composition according to the present invention can have a flexural strength of about 500 kgf/cm² to about 800 kgf/cm² and a flexural modulus of about 30,000 kgf % cm² to about 60,000 kgf/cm² measured in accordance with ASTM D790 at a speed of 2.8 mm/min, and a tensile strength of about 200 kgf/cm² to about 400 kgf/cm² and a tensile elongation of about 5% to about 15% measured in accordance with ASTM D638 at a speed of 5 mm/min.

The polycarbonate resin composition according to the present invention can have a heat distortion temperature of about 120° C. to about 135° C. measured in accordance with ASTM D648 in 18.56 kgf/cm².

The polycarbonate resin composition according to the present invention can be prepared by any suitable conventional methods as are well known to those skilled in the art. For example, the components of the invention and the optional additives can be mixed in a mixer at the same time and the mixture can be melt-extruded through an extruder in the form of pellets.

The polycarbonate resin composition according to the present invention can be used to manufacture articles that can have excellent thermal conductivity, impact strength, and moldability at the same time.

For example, the polycarbonate resin composition according to the present invention can be applied in materials for light emitting devices such as various electrical/electronic components, indoor lighting, automotive lighting, display device, headlight, and the like, for example, can be applied in a LED fluorescent lamp.

Methods for preparing an article from the polycarbonate resin composition according to the present invention are not specially limited. For example, extrusion molding, injection molding, casting molding, and the like can be used. The method of molding can be carried out easily by those skilled in the art.

The present invention will be further defined in the following examples, which are intended for the purpose of illustration and are not to be construed as in any way limiting the scope of the present invention.

### EXAMPLES

The particulars of each component used in Examples and Comparative Examples of the present invention are as follows:

(A) Polycarbonate resin

Polycarbonate (Product name: SC-1080) manufactured by Cheil Industries Inc is used.

(B) Thermally conductive filler

(B1) Magnesium oxide which is treated surface with vinyl, and has a particle size (diameter) of 50 μm (Product name: RF-50) manufactured by Ube is used.

(B2) Boron nitride (Product name: CF-600) manufactured by Momentive Performance Materials having a particle size (diameter) of 20 μm is used.

(B3) Aluminum oxide (Product name: DAW-45) manufactured by Denka having a particle size (diameter) of 50 μm is used.

(C) Modified polyolefin-based copolymer

MAH-HDPE, available under the name Bondyram® 5108 manufactured by Polyram is used.

### Examples 1 to 9 and Comparative Examples 1 to 6

The components as shown in Table 1 below are dried and mixed, and the mixture is extruded by using a twin screw extruder (Φ=45 mm) to be shaped into pellets. The resulting pellets are dried at 100° C. in dehumidification dryer for 4 hours, and are molded into test specimens.

The amounts of (A) and (1) in the following Table 1 are represented as % by weight based on 100% by weight of (A) and (B), and the amounts of (C) are represented by parts by weight based on 100 parts by weight of (A) and (B)

TABLE 1

| | | | | | | | | | | Comparative | |
|---|---|---|---|---|---|---|---|---|---|---|---|
| | | Examples | | | | | | | | Examples | |
| | | 1 | 2 | 3 | 4 | 5 | 6 | 7 | 8 | 1 | 2 |
| (A) | | 60 | 60 | 60 | 40 | 40 | 40 | 60 | 60 | 60 | 40 |
| (B) | (B1) | 40 | 40 | 40 | 60 | 60 | 60 | — | — | 40 | 60 |
| | (B2) | — | — | — | — | — | — | 40 | — | — | — |
| | (B3) | — | — | — | — | — | — | — | 40 | — | — |

| | | | | | | | | | | |
|---|---|---|---|---|---|---|---|---|---|---|
| (C) | 0.5 | 1.0 | 1.5 | 0.5 | 1.0 | 1.5 | 1.0 | 1.0 | — | — |

The test specimens are tested for various physical properties as follows and the results are set forth in Table 1 and FIG. 1 below.

(1) Thermally conductivity is measured for 1*1*1 mm³ specimen in accordance with ASTM E 1461 using Laser flash method.

(2) Izod impact strength (notched) is measured for ⅛ inch thick test specimen in accordance with ASTM D256.

(3) Melt flow index (fluidity) is measured in accordance with ASTM D1238 at 250° C. under 10 kg load.

(4) Flexural modulus (FS) and Flexural strength (FM) are measured for ¼ inch thick test specimen in accordance with ASTM D790 at a speed of 2.8 mm/min.

(5) Tensile strength (TS) and Tensile elongation (TE) are measured for ⅛ inch thick test specimen in accordance with ASTM D638 at a speed of 5 mm/min.

(6) Viscosity is measured in accordance with ASTM D648 at 270° C. using dynamic rheological measuring instrument (ARES) in 18.56 kgf/cm².

TABLE 2

| | | | | | | | | | Comparative | |
|---|---|---|---|---|---|---|---|---|---|---|
| | Examples | | | | | | | | Examples | |
| | 1 | 2 | 3 | 4 | 5 | 6 | 7 | 8 | 1 | 2 |
| Thermal | 0.60 | 0.61 | 0.60 | 0.81 | 0.80 | 0.80 | 1.70 | 0.55 | 0.60 | 0.80 |
| conductivity | | | | | | | | | | |
| (W/mk) | | | | | | | | | | |
| Izod impact | 9 | 12 | 15 | 7 | 8 | 10 | 8 | 10 | 3 | 2 |
| strength | | | | | | | | | | |
| (kgfcm/cm) | | | | | | | | | | |
| Melt flow index | 15 | 13 | 11 | 20 | 17 | 15 | 5 | 4 | 18 | 24 |
| (g/10 min) | | | | | | | | | | |
| Flexural strength | 730 | 700 | 670 | 560 | 540 | 520 | 520 | 730 | 900 | 590 |
| (kgf/cm²) | | | | | | | | | | |
| Fexural modulus | 36000 | 35000 | 34000 | 56000 | 54000 | 52000 | 48000 | 34000 | 39000 | 67000 |
| (kgf/cm²) | | | | | | | | | | |
| Tensile strength | 400 | 380 | 360 | 260 | 250 | 250 | 210 | 380 | 530 | 350 |
| (kgf/cm²) | | | | | | | | | | |
| Tensile | 8 | 12 | 13 | 6 | 8 | 8 | 2 | 7 | 3 | 1 |
| elongation (%) | | | | | | | | | | |
| Heat resistance | 132 | 131 | 130 | 128 | 125 | 126 | 132 | 131 | 133 | 130 |
| (° C.) | | | | | | | | | | |

As shown in Table 2, Examples 1-8 including the modified polyolefin-based copolymer (C) exhibit excellent thermally conductive, as well as excellent Izod impact strength and fluidity (melt flow index). Also, as shown in Examples 2, 7, and 8, Example 7 including magnesium oxide exhibits the best impact strength and fluidity (melt flow index).

As shown in Examples 1-3, as the amount of the modified polyolefin-based copolymer (C) increases, Izod impact strength as well as tensile elongation increases.

Also, as shown in Examples 4-6, although excess thermally conductive filler (B) is used, Examples 4-6 exhibit excellent Izod impact strength because of using the modified polyolefin-based copolymer (C).

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

1. A polycarbonate resin composition comprising;
(A) a polycarbonate resin;
(B) a thermally conductive filler having a spherical shape; and
(C) about 0.1 to about 5 parts by weight of a modified polyolefin-based copolymer based on about 100 parts by weight of a base resin including about 20 to about 80% by weight of the polycarbonate resin (A) and about 20 to about 80% by weight of the thermally conductive filler (B);
wherein the polycarbonate resin composition has an Izod notch impact strength of about 5 to about 20 kgf·cm/cm measured for 3.175 mm (⅛″) thick specimen in accordance with ASTM D256.

2. (canceled)

3. The polycarbonate resin composition of claim 1, wherein the thermally conductive filler (B) comprises magnesium oxide, boron nitride, aluminum oxide, or a combination thereof.

4. (canceled)

5. The polycarbonate resin composition of claim 1, wherein the modified polyolefin-based copolymer (C) comprises a functional group selected from the group consisting of maleic anhydride, amine, and epoxy functional groups.

6. The polycarbonate resin composition of claim 1, further comprising an additive selected from the group consisting of antimicrobial agents, thermostabilizers, antioxidants, release agents, photostabilizers, inorganic additives, surfactants, coupling agents, plasticizers, compatibilizing agents, lubricants, antistatic agents, coloring agents, flame retardants, auxiliary flame retardants, anti-dripping agents, ultraviolent stabilizers, ultraviolet absorbers, UV-protecting agents and combinations thereof.

7. The polycarbonate resin composition of claim 1, wherein the polycarbonate resin composition has a thermal conductivity of about 0.4 W/mK to about 2.0 W/mK measured for 1*1*1 mm³ specimen in accordance with ASTM E1461 using the Laser flash method.

8. The polycarbonate resin composition of claim 1, wherein the polycarbonate resin composition has a melt flow index of about 4 g/10 min to about 25 g/10 min measured in accordance with ASTM D1238 at 250° C. under a 10 Kg load.

9. A molded article comprising the polycarbonate resin composition of claim 1,

10. The molded article of claim 9, wherein the article is a fluorescent lamp.
